(19) United States
(12) Patent Application Publication
(10) Pub. No.: US 2012/0217719 A1
(43) Pub. Date: Aug. 30, 2012

(54) Mud flap holder

(76) Inventor: Thomas Edward Moore, Naples, FL (US)

(21) Appl. No.: 12/932,428

(22) Filed: Feb. 25, 2011

(51) Int. Cl. B62D 25/18

(52) U.S. Cl. 280/154

(57) ABSTRACT

A mud flap holder for securing a mud flap to a motor vehicle includes a base plate, a pivot plate, and a securing mechanism. The base plate mounts to a vehicle. The pivot plate is connected to the base plate via a hinge. The securing mechanism secures the base and pivot plates in a locked position, which frictionally secures a mud flap between the base and pivot plates.

### FIELD OF THE INVENTION

The present invention relates to mud flaps, and more specifically, to mud flap holders.

### BACKGROUND OF THE INVENTION

Mud flaps are safety equipment for vehicles. They are generally square or rectangular elements, and are positioned behind the wheels of a vehicle to block water and/or debris projected rearwardly from the wheels as the vehicle is moving.

### BRIEF SUMMARY OF THE INVENTION

It is, therefore, an object of the present invention to provide a mud flap holder.

In an exemplary embodiment, the present invention can be embodied in a mud flap holder for securing a mud flap to a motor vehicle. Such a mud flap holder can include a base plate, a pivot plate, and a securing mechanism.

In an exemplary aspect of the present invention, a base plate can include a first base plate end and a second base plate end, and the base plate can be adapted to mount to the vehicle such that the first and second base plate ends are aligned along a plane parallel to a wheel axle of the vehicle.

In another exemplary aspect of the present invention, a pivot plate can include a first pivot plate end, a second pivot plate end, and a contact surface formed of a continuous material, and the pivot plate can be connected to the base plate via a hinge attached to the first base plate end and the first pivot plate end.

In a further exemplary aspect of the present invention, a securing mechanism can be adapted to secure the base plate and the pivot plate together in a locked position when the pivot plate is pivotably positioned substantially parallel with the base plate.

In yet another exemplary aspect of the present invention, the pivot plate can be adapted to frictionally secure a mud flap disposed between the contact surface and the base plate when the mud flap holder is in the locked position.

In still a further exemplary aspect of the present invention, optionally, at least one of the contact surface and the base plate can includes one or more protrusions adapted to abut a mud flap disposed between the contact surface and the base plate when the mud flap holder is in the locked position.

### BRIEF DESCRIPTION OF THE DRAWINGS

The present invention is illustrated by way of example, and not in limitation, in the figures of the accompanying drawings, in which:

FIG. 1 illustrates a top-view perspective of an exemplary mud flap holder in an unlocked position.

FIG. 2 illustrates a top-view perspective of an exemplary mud flap holder in a locked position.

FIG. 3 illustrates a side-view perspective of an exemplary base plate having a double-hinged extension provided in a dual configuration.

FIG. 4 illustrates a top-view perspective of an exemplary base plate having exemplary protrusions.

FIG. 5 illustrates a side-view perspective of an exemplary base plate having an exemplary aperature.

FIG. 6 illustrates a side-view perspective of an exemplary pivot plate having an exemplary notch.

FIG. 7 illustrates an exemplary securing mechanism in the form of a quick release skewer.

FIG. 8 illustrates a top-view perspective of another exemplary mud flap holder in an unlocked position.

FIG. 9 illustrates a top-view perspective of an another exemplary mud flap holder in a locked position.

### DETAILED DESCRIPTION OF THE INVENTION

The invention will now be described in more detail by way of example with reference to the embodiments shown in the accompanying figures. It should be kept in mind that the following described embodiments are only presented by way of example and should not be construed as limiting the inventive concept to any particular physical configuration, shape, size, or order.

As illustrated in FIG. 1, the present invention can be embodied in a mud flap holder that includes a base plate 110 having a first base plate end 112 and a second base plate end 114; and a pivot plate 120 having a first pivot plate end 122, a second pivot plate end 124, and a contact surface 126 formed of a continuous material. As further illustrated, pivot plate 120 can be connected to base plate 110 via a hinge 130 attached to first base plate end 112 and first pivot plate end 122.

According to the present invention, a hinge is not limited to the exemplary hinge shown in the figures; rather, a hinge is to include any type of structural element providing a mechanical hinging function consistent with the present invention.

In an exemplary aspect of the present invention, base plate 110 is adapted to be mounted to a vehicle (not shown) such that first and second base plate ends 112, 114 are aligned along a plane parallel to a wheel axle of the vehicle. Mounting can be effectuated by any manner desired. Exemplary mounting can be effectuated via one or more bolts (and nuts) and/or welding, for example and not in limitation.

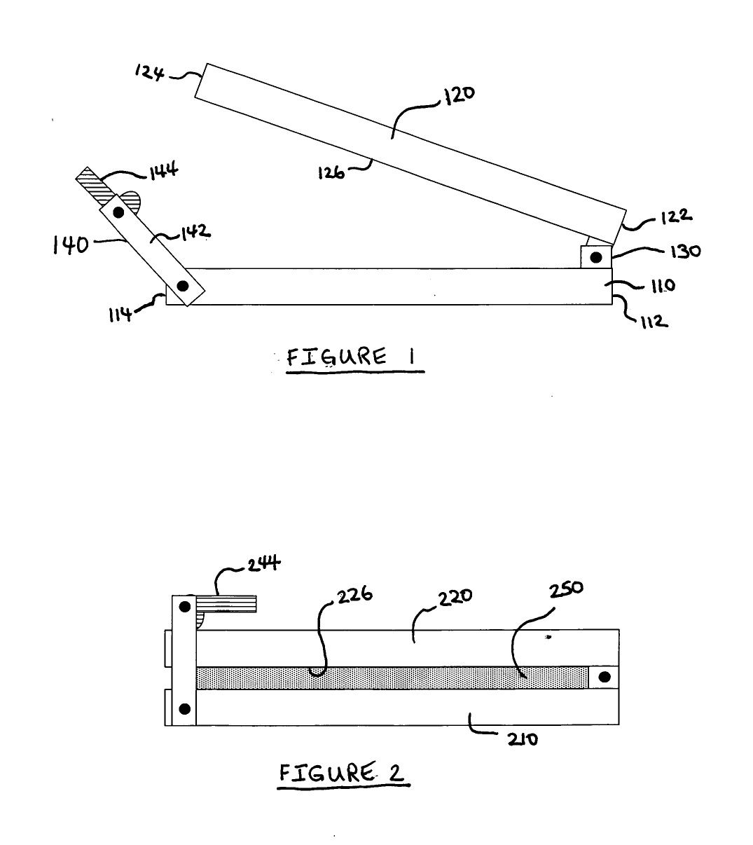

FIG. 1 also illustrates an exemplary securing mechanism 140 adapted to secure base plate 110 and pivot plate 120 together in a locked position (shown in FIG. 2) when the pivot plate is pivotably positioned parallel with the base plate. Illustratively, in one exemplary embodiment, securing mechanism 140 can include a double-hinged extension 142 and an actuator 144. It should be noted that the present invention is not limited to the specific securing mechanism illustrated; rather, any form of mechanism can be utilized to the extent such mechanism is functionally compatible with the present invention.

FIG. 2 illustrates an exemplary mud flap holder in a locked position and having an exemplary mud flap 250 positioned between base plate 210 and pivot plate 220. Notably, contact surface 226 includes the portion of pivot plate 220 that contacts mud flap 250. As illustrated, pivot plate 220 can be pivotably positioned to be parallel with base plate 210, which compresses mud flap 250 such that the base and pivot plates secure the mud flap in position via static friction. Further, actuator 244 can be pivoted to push pivot plate 220 towards base plate 210, which provides a compression force.

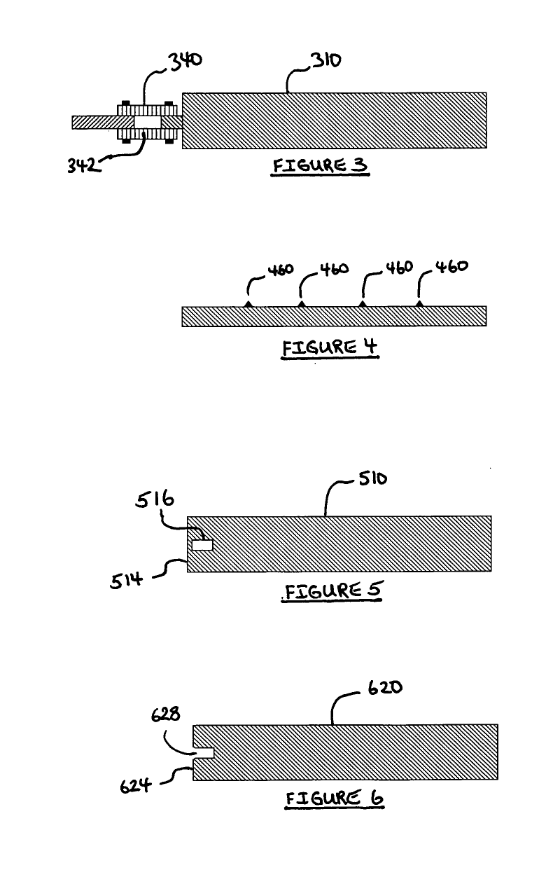

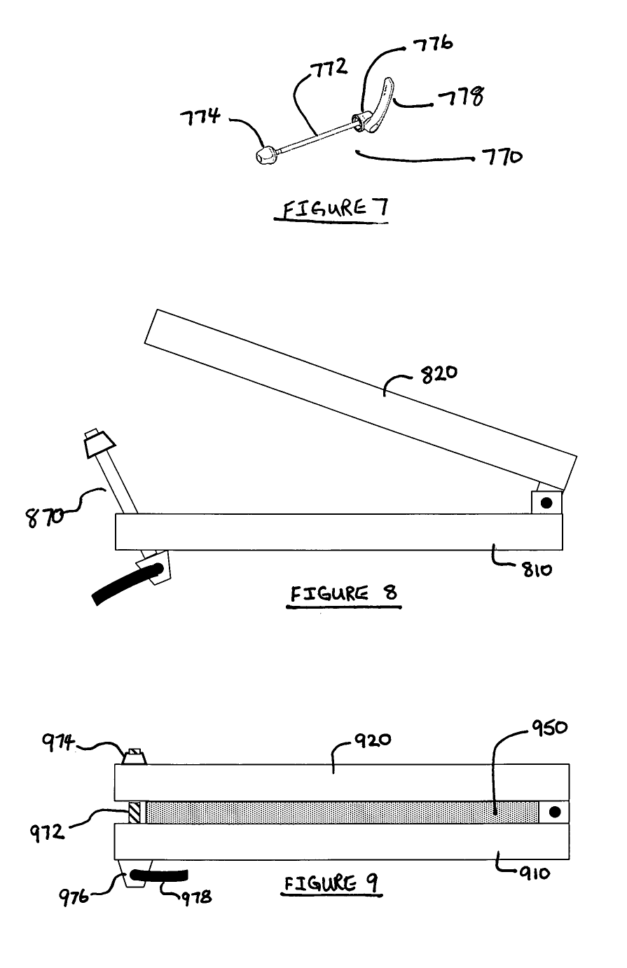

FIG. 3 illustrates another perspective of base plate 310 and securing mechanism 340. As illustrated, a double-hinged extension 342 can be provided in a dual configuration.

In another exemplary aspect of the present invention, base plate 110 and pivot plate 120 can be formed of any desired material consistent with the present invention, such as, for example and not in limitation, any type of metal or plastic.

As illustrated in FIG. 1-3, base plate 110 and pivot plate 120 can be provided with substantially flat inner surfaces for frictional contact with a mud flap. However, as illustrated in FIG. 4, one or more optional protrusions 460 can be provided on any of such surfaces to improve the securing of a mud flap in a fixed position.

FIGS. 5 and 6 illustrates still yet further exemplary aspects of the present invention, in which base plate 510 can include an aperture 516 at second base plate end 514; and pivot plate 620 can include a notch 628 at second pivot plate end 624. In an exemplary aspect of the present invention, aperture 516 and notch 628 cooperatively allow the utilization of a quick release skewer (illustrated in FIG. 7-9). It should be noted that the locations of aperture 516 and notch 628 may be switched if so desired.

FIG. 7 illustrates an exemplary quick release skewer 770 having a rod 772 with a threaded end, an abutment element 774 (such as, for example and not in limitation, a nut with an optional washer) on the threaded end, and a cam 776 on the other end. Cam 776 includes a lever 778, which can be rotated clockwise or counterclockwise to move rod 772 towards or away from cam 776. It should be noted that alternative elements can be utilized in place of cam 776, such as a wing nut, threaded knob, or other functionally similar hand-tightening structure, for example and not in limitation.

As illustrated in FIG. 8, quick release skewer 870 can be inserted through the aperture (not shown) in base plate 810, and pivot plate 820 can be pivoted to an open position to accept a mud flap (not shown). As illustrated in FIG. 9, with mud flap 950 positioned against base plate 910, pivot plate 920 can be pivoted to abut mud flap 950, which is then frictionally held between base plate 910 and pivot plate 920. Accordingly, rod 972 can be moved to pass through the notch (not shown) in pivot plate 920, with abutment element 974 and/or cam 976 being rotated along rod threads to reduce the distance between the abutment element and cam. Lever 978 can next be rotated to provide a compression force that securely holds mud flap 950 in place.

It will be apparent to one of ordinary skill in the art that the manner of making and using the claimed invention has been adequately disclosed in the above-written description of the exemplary embodiments and aspects taken together with the drawings.

It should be understood, however, that the invention is not necessarily limited to the specific embodiments, aspects, arrangement, and components shown and described above, but may be susceptible to numerous variations within the scope of the invention.

Accordingly, the specification and drawings are to be regarded in an illustrative and enabling, rather than a restrictive, sense.

Therefore, it will be understood that the above description of the embodiments of the present invention are susceptible to various modifications, changes, and adaptations, and the same are intended to be comprehended within the meaning and range of equivalents of the appended claims.

Therefore, I claim:

1. A mud flap holder for securing a mud flap to a motor vehicle, comprising:
a base plate having a first base plate end and a second base plate end, said base plate being adapted to mount to the vehicle such that the first and second base plate ends are aligned along a plane parallel to a wheel axle of the vehicle;
a pivot plate having a first pivot plate end, a second pivot plate end, and a contact surface formed of a continuous material, said pivot plate being connected to said base plate via a hinge attached to the first base plate end and the first pivot plate end; and
a securing mechanism adapted to secure said base plate and said pivot plate together in a locked position when said pivot plate is pivotably positioned substantially parallel with said base plate;
wherein said pivot plate is adapted to frictionally secure a mud flap disposed between the contact surface and said base plate when the mud flap holder is in the locked position.

2. The mud flap holder of claim 1, wherein at least one of said base plate and said pivot plate is formed at least in part of a metal.

3. The mud flap holder of claim 1, wherein at least one of said base plate and said pivot plate is formed at least in part of a plastic.

4. The mud flap holder of claim 1, wherein at least one of the contact surface and said base plate includes one or more protrusions adapted to abut a mud flap disposed between the contact surface and said base plate when the mud flap holder is in the locked position.

5. The mud flap holder of claim 1, wherein said pivot plate is formed of the continuous material.

6. The mud flap holder of claim 1, wherein said base plate is mounted to the vehicle by welding.

7. The mud flap holder of claim 1, wherein said securing mechanism is a quick release skewer.

8. The mud flap holder of claim 7, wherein said securing mechanism includes a wing nut.
